(19) United States
(12) Patent Application Publication
(10) Pub. No.: US 2004/0024899 A1
(43) Pub. Date: Feb. 5, 2004

(54) Method and system for multi-platform display distribution

(76) Inventors: Oliver Sturrock, London (GB); Frederick Haigh Jowett, London (GB)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 10/380,495

(22) PCT Filed: Sep. 13, 2001
(86) PCT No.: PCT/GB01/04098

(30) Foreign Application Priority Data
Sep. 14, 2000 (GB) 0022588.8

(51) Int. Cl. G06F 15/16

(52) U.S. Cl. 709/231; 709/246; 709/232

(57) ABSTRACT

A system configured to distribute data in a user specified manner, comprising: means for receiving requests for data from at least one client; and means for configuring data to be in a form compatible with a platform upon which the client is supported, and for distributing data to said client, said data configured in accordance with said user specification. The present invention provides a method and system for providing continuity of data/information/services to a user alongside portability with respect to the supporting platform.

This invention relates to the distribution of data. More specifically, this invention relates to the distribution of data representative of a system user's preferences, such as a “look and feel”, and the information and/or services which that user requires, to that user, irrespective of the hardware platform the user is utilising to request and receive such data. This invention enables the user's requirements to be provided for without the requirement of manual adjustment when changing between platforms.

At the present time, if a user wishes to use concurrently a number of services upon a platform, such as a palmtop or laptop computer, an internet enabled telephone or a WAP phone etc., each of these services will utilise or require its own application display. As such, when a user wishes to view one service, whilst running another application simultaneously, he must switch between the applications or views, selecting the currently desired one to be the primary or foreground view/application. It is evident that this is undesirable. If a user wishes to utilise several applications simultaneously, problems may occur, causing frustration to that user.

It is far preferable to the user to be able to configure a display or application to present the services or information that are required in a way which is pleasing to them and also in such a way as to ease use. Ultimately, it would be preferable to have an application which allows a user to configure all services and the like which they require to utilise in the most convenient way for themselves.

Further problems lie in the portability of systems and continuity of system applications. If a user configures an application to appear in the way preferred by that user and subsequently an error occurs within the platform used to support the application, it is very possible that the user's preferred configuration will be lost, thereby causing the user to have to reconfigure the application, or utilise it in an undesired format. Similarly, if a user changes the platform upon which they operate applications, or utilise services etc., the whole configuration process must be carried out again. And, there is by no means any guarantee that the same configuration, or even application, will be supported on a different platform. Thus, problems in portabilty and continuity are evident.

In the light of the foregoing, the present invention provides a system configured to distribute data in a user specified format comprising:

means for receiving requests for data from at least one client; and

means for configuring data to be in a form compatible with a platform upon which the client is supported, and for distributing data to said client, said data configured in accordance with said user specification.

Also in accordance with the present invention, there is provided a system configured to distribute data to at least one client, in a user specified format, wherein a single source of data is utilised to support requests from at least one client from a plurality of different supporting platforms. Preferably the system will further comprise: means for receiving requests for data from at least one client and means for configuring and distributing data to the client in a form compatible with the platform supporting the client.

Preferably, the request for data includes a request for a user's current preferences, and a request for services and/or information of interest to the user. The system may further comprise: means for generating a user data requirements specification; and means for generating an updated user data requirements specification from the first generated specification and at least one style specification.

More preferably, one style specification may represent a user's visual preferences, another may represent a corporate or similar branding scheme, and another may represent the client's supporting platform capabilities/requirements.

In a particular embodiment, a user data request may be in the form of an extensibl markup language (XML) document and a style specification may be in the form of an extensible style language (XSL) stylesheet.

Preferably the system further comprises means for transmitting the updated user data request specification to the client.

Preferably, the client comprises:

means for translating and generating a display from the updated user data requirements specification;

means for storing data not yet required for display;

means for receiving user input;

means for requesting that preferences be changed and/or requesting that services and/or information be provided to the client and/or interacting with one or more services; and

means or receiving services and/or information.

Also in accordance with the present invention, there is provided a system configured to generate display media from a user data requirements specification, the system comprising:

means for generating an updated user data requirements specification from the requirements specification and each of at least one style specification; and

means for distributing such updated specification to a display generation engine.

Preferably, one style specification represents a user's visual preferences, another represents a corporate or similar branding scheme, and another represents a client's supporting platform capabilities/requirements.

In a particular embodiment, a user data request specification is in the form of an XML document and a style specification is in the form of an extensible style language (XSL) stylesheet.

Also in accordance with the present invention, there is provided a method of automatically distributing data, and information and/or services to a system user in a user specified manner, comprising the steps of:

determining the type of a platform supporting a client making a request;

accessing any user preferences and a platform capabilities/requirements specification;

generating a user data requirements specification for transmission to the client, and

transmitting such to the client.

Preferably, the method further comprises the steps of:

generating a display from the received data requirements specification;

transmitting a request for dynamic or real-time services and/or information to be provided;

receiving the requested services and/or information; and

displaying the services and/or information along with the display generated previously.

More preferably, the method further comprises the step of interacting with a received service.

Still more preferably, the step of generating the user data request specification for transmission to the client comprises:

generating a first user data requirements specification from the user request;

applying user preferences, if present, to the specification, thereby creating an updated or second specification;

applying a corporate or similar branding scheme, if present, to the second specification, if present, otherwise the first specification, thereby creating a third specification; and

applying a platform capabilities/requirements style to the third specification, if present, otherwise the second specification, if present, otherwise the first specification, thereby creating a specification for transmission.

A specific embodiment of the present invention is now described, by way of example only, with reference to the accompanying drawings, in which:

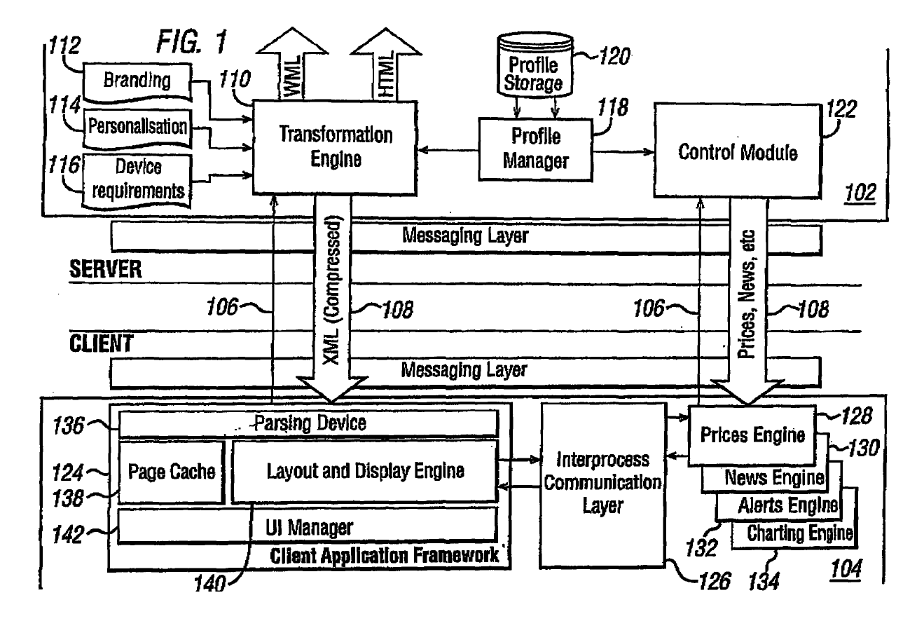

FIG. 1 is a high level architecture representation of a system according to the present invention;

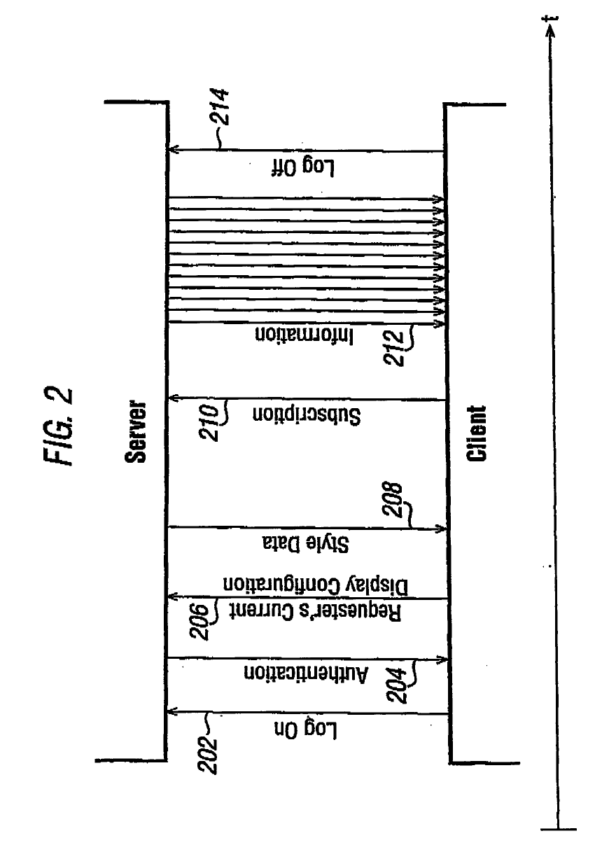

FIG. 2 is a time line indicating the exchange of messages between a client and server according to the present invention;

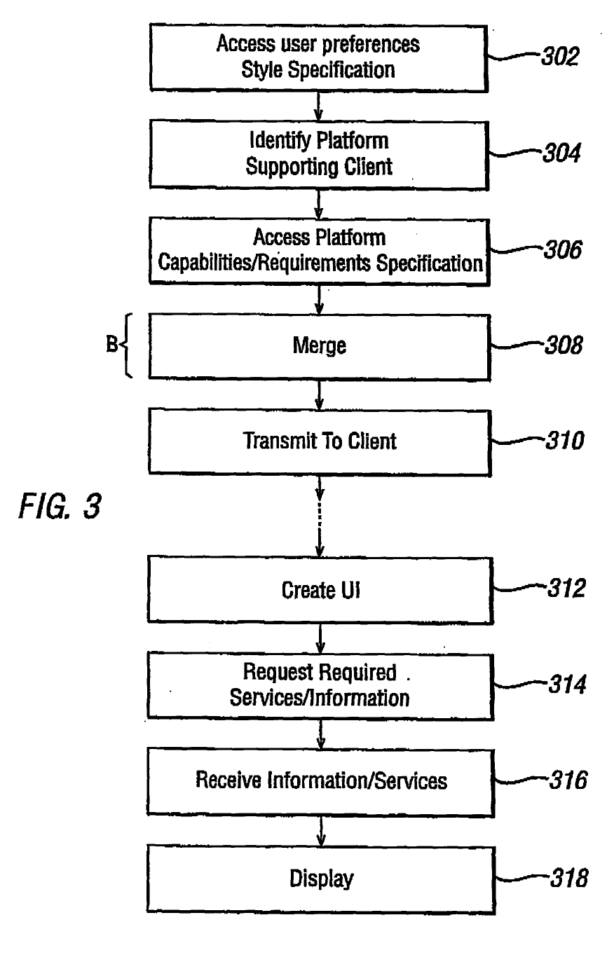

FIG. 3 is a flow diagram indicating a method according to the present invention;

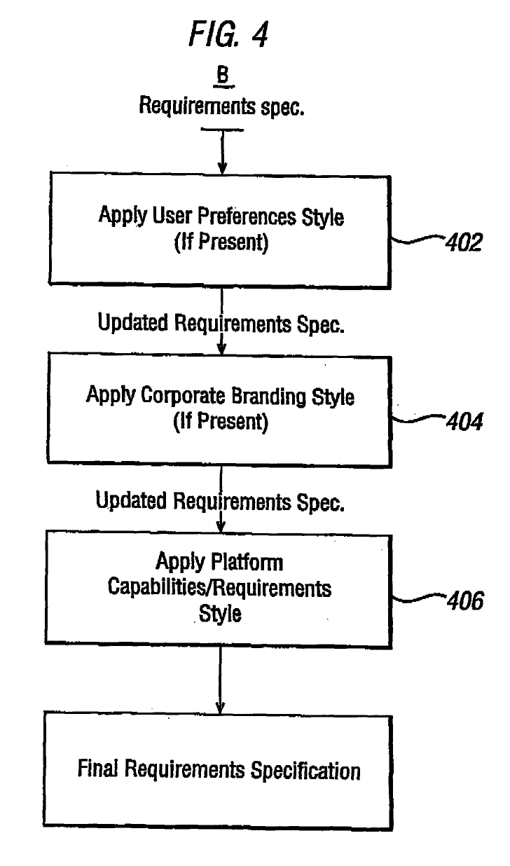

FIG. 4 is a flow diagram detailing one step of the flow diagram of FIG. 3;

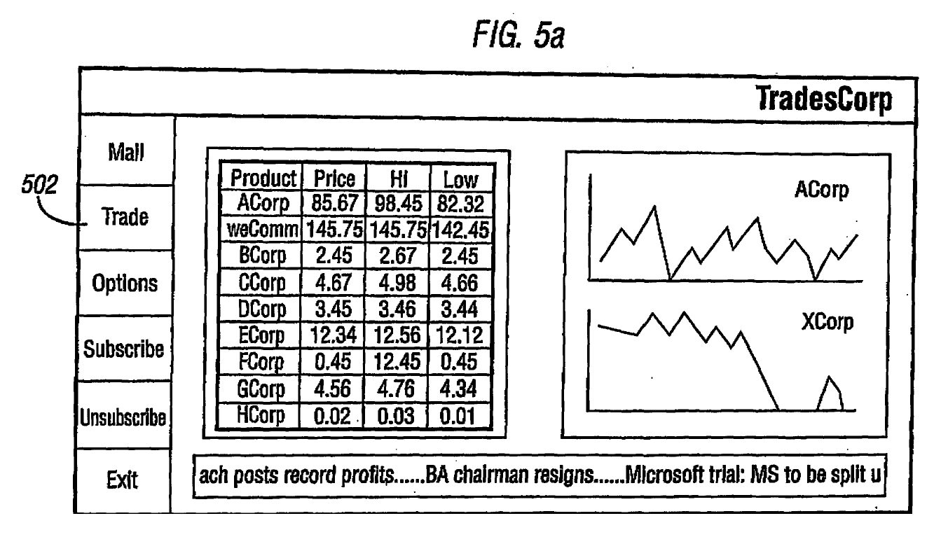

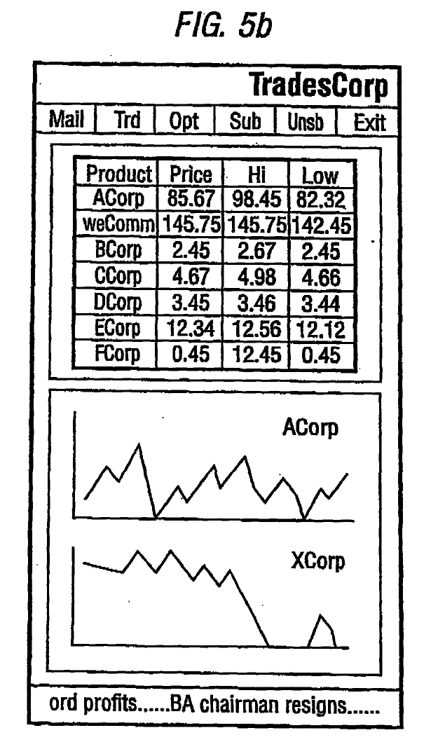

FIG. 5a is a representation of an application display generated in accordance with the present invention; and

FIG. 5b is a representation of an alternative application display generated in accordance with the present invention.

Referring to FIG. 1 of the drawings, the data distribution system consists of a number of separate entities. Firstly there is a server or system main module 102. Secondly, there is a client 104. It is evident that various communications 106, 108 occur between these primary entities. The communications 106, 108 are described in more detail below with reference to FIG. 2. The two primary entities are further comprised of sub-entities.

The server is comprised of a transformation engine 110, which is in communication with resources or style specifications 112, 114, 116. These specifications contain information about corporate branding, about personal preferences of users and about platform capabilities/requirements. Other such style specifications may also be present within the server. Also within the server are a profile manager 118, a profile storage entity 120 and a control module 122.

The client 104 comprises a client application framework 124, an interprocess communication layer 126 and a plurality of content engines 128, 130, 132, 134. Possible examples of content engines for a stocks and shares trading application utilising this platform architecture include a price engine 128, a news engine 130, an alerts engine 132 and a charting engine 134. These engines are configured to request and receive specific sorts of information and/or services from the control module 122 within the server 102. Any type of information or service conceivable may be required and thus corresponding content engines may be provided within a client.

The client application framework is made up from a number of individual elements. These consist of a parsing device 136, a page cache 138, a layout and display engine 140 and a user interface managing module 142.

Looking in more detail at various of the above-mentioned elements, the readers understanding of the system of the present invention will be facilitated. Firstly, the profile manager 118 and profile storage entity 120 are described. These elements store the products/information/services that a particular user is interested in. Therefore, a profile will exist for each registered user of the system and will be stored and managed by these entities respectively. Additionally, the profile of each user contains information relating to that user's layout and configuration preferences. When a client requests that a profile be transmitted or passed to it, the profile manager references the stored data (i.e. within the profile storage entity 120) and generates a high level user data requests specification. Such a specification is merely an indication of services etc., in which the user utilising the client is interested. In one particular embodiment, the specification produced is a high level XML representation or document

When looking at the transformation engine 110 and the style specifications 112, 114, 116. It will be of use to detail style itself. Style refers to a user's choice of font and colour to be generated by an application for display. In other words, style refers to the “look and feel” of the application. Of course, this may consist merely of a single user's preferences, but may also be based upon a consistent scheme such as a corporate or similar branding scheme. In such an instance, all users within an institution would experience generally the same look and feel.

Each individual's preferences may also be added to a corporate look and feel thereby providing a degree of personalisation.

A further aspect of style is connected with the display capabilities of the client platform in use at any one time. As an example, it is feasible that a single user may migrate from one platform to another, e.g. from a 640×240 16-grey PSION series 5mx to a 240×320 4096-colour HP Jomada 540, to a 1024×768 16 million-colour Sony Valo, and still expect the appearance of the application or applications to be run thereon to remain much the same. Thus, there is a requirement for continuity and affinity of style.

The transformation engine 110 utilises the appropriate style specifications 112, 114, 116, which are determined on a user by user basis, to update the user data requirements specification stored within the profile storage entity 120. The updated specification is of a much lower level, unintelligible to a human reader, but of real use to the client layout and display engine 140. In one particular embodiment, the style specifications are in the form of extensible style language (XSL) stylesheets. Such sheets are capable of governing the translation of an XML document into another presentation system specific language, such as hypertext markup language (HTML).

The stylesheets which may be applied within the system include, but are not limited to the following:

Branding—It is likely that institutions will want to apply their own logos, colour schemes and fonts to any client application they wish to provide to their end use. This stylesheet may be stored as part of a broader corporate profile.

Personalisation—this has a similar purpose to the branding stylesheet above in that it represents a user's customised colour schemes and fonts. This sheet is not intended to determine which services and products a user has requested, but it is used to store such details as whether to display prices on the left of a screen at the top, etc. for example. Stylesheets are stored as part of the user's profile.

Device translation or platform capabilities/requirements—these stylesheets will comprise a set of templates, which cover all of the platforms for which the client application is available. These are the components that determine that the screen orientation on a certain device would better support a certain layout than another, and will override the user's performances in that regard. These stylesheets may carry out the translations from colour descriptions to grey scale, and may disable audio screens for devices with no audio output, etc.

The client application framework 124 is now described in more detail. The parsing device 136 is a module that interprets an incoming data stream from the server 102 and breaks it down into a document model which is passed to the page cache 138, and then to the layout and display engine 140 for display.

The page cache 138 is a component that is responsible for instructing the layout engine 140 to generate the various screens or pages which are a part of the client application. The scope of a page, however, is not limited to the main application screens, but is extended to the various forms, dialogs and message boxes that allow the user to interact with the system. The page cache 138 maintains a set of recently used page layouts and subsidiary page descriptions that may be required quickly. Thus, forms and dialogs, downloaded with the primary page description but not displayed until needed, are stored by the page cache 138 and presented when necessary.

The layout and display engine 140 generates the various elements to be presented on a platform screen. The nature of the work performed by the layout engine is threefold. Firstly, it generates static elements to be displayed when a page is loaded (and keeps them refreshed as necessary). Secondly, it generates display media representative of dynamic content provided by the various content ngines, such as the prices content engine, and thirdly, it generates interactive graphical user interface elements as demanded by the user interface manager.

The content of the application display is now referred to for completeness. The content is the information of interest to the user. It can be static or dynamic in nature and, generally, dynamic content is synonymous with real-time content. Static content is very limited in usefulness and is relatively straightforward. It is refreshed only when the application is initialised and may contain such information as a “message of the day”, etc. The dynamic content is the prices, charts, news, alerts and any other item of requested and delivered data. This leads onto the content provision engines 128 to 134.

The content provision engines represent all possible content feeds that may be displayed in the client application. There is one engine per type of data feed, and these engines are processes that sit in the background receiving the data from the server, which filters and discriminates the data being supplied to the client based upon the user's preferences as stored in the profile, and determined by the profile manager 118. The data for display is then sent to the client application framework layout engine 140 which generates the relevant content in the relevant places on the screen.

The operation of the system of the present invention is now described with reference to FIGS. 2-5. Referring to FIG. 2, the messages exchanged by server and client are depicted. As may be seen, interaction begins with a request 202, from a client to a server, to log on to the server. Once the user has been authenticated, a communication 204 that the user is logged on is passed back to the client. Next, the client makes a request 206 that its current user display configuration be transmitted. Such data is transmitted 208 to the client by the server. The server then requests 210 the transmission of dynamic information or services etc. from the server. Such services are provided 212. Communications 206 and 208 may be repeated if the user chooses to change their preferred style, tc. However, transmission of dynamic information, etc., will continue until such time as the cli nt logs off 214 from the server.

FIG. 3 shows the steps which are taken when a client sends a request to the server that a user's current display configuration be transmitted thereto. Firstly, the profile manager 118 composes a user data requirement specification that describes the services requested by the user. As an example, a user is interested in the prices of a set of 10 products, certain charts and certain news items.

The request for data to be sent to a client carries with it details as to the platform supporting the client. This enables the system to automatically provide, substantially, a user's preferred format irrespective of the platform currently supporting the user's client. This will be described in detail below.

The next step (function box 302) consists of the profile manager 118 accessing the style specifications 114, 116 relating information about any corporate or similar branding relevant to the user, and relating the user's personal display preferences. Continuing the above example, the user may prefer to see prices in a panel on the left charts on the right and news headlines scrolling along the bottom of the screen in red on a black background.

As may be seen in function box 304, the profile manager 118 uses the information about the client platform in the request to determine what the platform is. The profile manager 118 then accesses the platform specific device translation or platform capabilities/requirements specification 116 (function box 306). This style specification is applied to the user data requirements specification as will be described.

Function box 308 details the step during which the various style specifications accessed along with the user data requirements specifications are sent to the transformation engine 110. The transformation engine merges the style specifications and requirements specification, as will be described with reference to FIG. 4 below, to produce a new user data requirements specification. This new specification is then transmitted to the client (function box 310) in a way suitable to the client server relationship, i.e. by fixed line communication or via a wireless interface, etc.

At the client 104, the data received from the server 102 is used to create a user interface (function box 312). Firstly, the data is passed to the parsing device 136. This breaks the incoming data stream down into a model of the client application display and passes the relevant parts to the layout engine 140 to create the user interface display, and to the user interface manager 142 to monitor the user interface generated for input from the client user and any other events.

The layout engine 140 contacts the content engines, in this example the prices engine 128, the charting engine 134 and the news engine 130, and requests the required products/services therefrom (function box 314). These content engines connect with the server control module 122 and start to receive data/information/services transmitted thereby. Such data etc. is passed to layout engine 140, post formatting, and is displayed (function boxes 316, 318).

The layout engine 140 refreshes and updates the screen as required by the data it is receiving. A screen which may be generated in the above example is shown in FIG. 5a. In this example, interaction with the services provided may be in the form of deciding on a button to call up a new screen to enable the user to, for example, trade in stocks and shares. In the above example, a user decides to send a trade request to his broker and hits the trade button 502. This event is captured by the user interface manager 142 which looks at the page cache 138 and retrieves the layout for a previously stored trading form, which it passes to the layout engine 140 for rendering and display. The user interface manager monitors the user's interaction with this form and, at the relevant moment, a trade request is created and sent to the server. The request is then acted upon by the system.

One strength of th system will be more fully appreciated when reading the following. If a user logs on to the server using a different platform or device, as before the profile manager 118 retrieves the various profil lements relating to the user that are stored. However, this time the platform capabilities/requirements specification appropriate to the different platform is applied by the transformation engine 110. An exemplary display generated on a new or different platform with different sizings, etc. may be seen in FIG. 5b. In this example, since there is little room down the side of the screen on the new platform for the user interface buttons, these have been automatically displayed along the top of the screen, underneath a brand banner. The transformation engine 110 has also decided that the prices and charts should sit one on top of the other, as opposed to along side one another. The available space for price products has also decreased, and the client application framework now only requests 7 such items instead of the previous 9. As such, user's preferences are utilised to the extent possible irrespective of the platform used to access the server.

The operation of the step of merging style and user requirements specifications is now described with reference to FIG. 4. As may be seen, in function box 402, the merging step firstly applies the user preferences style specification to the user data requirement specification. This step is carried out in the transformation engine 110 and produces an updated requirements specification.

The second step consists of applying the corporate or similar branding style specification to the updated requirements specification, thereby producing a further updated requirement specification (function box 404). Of course, if either of the first two described style specifications are absent, the corresponding step will be omitted, and only the specification present will be utilised. If neither are present only the next step (function 406) will be carried out.

In function box 406, the appropriate device translation or platform capabilities/requirements specification is applied to the further updated requirement specification. This style specification will always be present. Th application thereof produces a final specification that is then transmitted to the client.

From the above it will be evident to the reader that the described system need only contain a single source of data for use by all platforms supported thereby. It is not necessary to retain the same data source, but with different formatting, in order to provide such support. This is because all formatting is applied to the data, within the server, pre-transmission to the client. An advantage of this feature resides in a reduction in required memory.

Whilst this invention has been described with reference to the use of the XML and XSL languages, it is by no means limited thereto. Any suitable means of expressing styles and requirements is equally applicable.

It will of course be understood that the present invention has been described above by way of example only, and modifications of detail can be made within the scope of the invention.

1. A system configured to distribute data in a user specified format comprising:
means for receiving requests for data from at least one client; and
means for configuring data to be in a form compatible with a platform upon which the client is supported and for distributing data to said client, said data configured in accordance with said user specification.

2. A system configured to distribute data to at least one client, in a user specified format wherein a single source of data is utilised to support requests from the at least one client from a plurality of different supporting platforms.

3. A system as claimed in claim 2, comprising:
means for receiving requests for data from at least one client;
means for configuring and distributing data to the client in a form compatible with the platform supporting the client.

4. A system as claimed in either of claims 1 or 3, wherein the request for data includes a request for a user's current preferences, and a request for services/information of interest to the user.

5. A system as claimed in any of claims 1, 3 or 4, wherein the system further comprises:
means for generating a user data requirements specification; and
means for generating an updated user data requirements specification from the first generated specification and at least one style specification.

6. A system as claimed in any of claims 1 or 3 to 5, wherein one style specification represents a user's visual preferences.

7. A system as claimed in any of claims 1 or 3 to 6, wherein one style specification represents a corporate or similar branding schem.

8. A system as claimed in any of claims 1 or 3 to 7 wherein one style specification represents the clients supporting platform capabilities/requirements.

9. A system as claimed in any of claims 1 or 3 to 8, wherein a user data request specification is in the form of an XML document.

10. A system as claimed in any of claims 1 or 3 to 9, wherein a style specification is in the form of an extensible style language (XSL) stylesheet.

11. A system as claimed in any of claims 5 to 10, further comprising means for transmitting the updated user data requirements specification to the client.

12. A system as claimed in claim 11, wherein the client comprises:
means for translating and generating a display from the updated user data requirements specification;
means for storing data not yet required for display;
means for receiving user input;
means for requesting that preferences be changed and/or requesting that services and/or information be provided to the client and/or interacting with one or more services; and
means for receiving services and/or information.

13. A system configured to generate display media from a user data requirements specification, said system comprising:
means for generating an updated user data requirements specification from the requirements specification and each of at least one style specification; and
means for distributing such updated specification to a display generation engine.

14. A system as claimed in claim 13, wherein one style specification represents a user's visual preferences.

15. A system as claimed in ither of claims 13 or 14, wherein one specification represents a corporate or similar branding scheme.

16. A system as claimed in any of claims 13 to 15, wherein one style specification represents a client's supporting platform capabilities/requirements.

17. A system as claimed in any of claims 13 to 16, wherein a user data request specification is in the form of an XML document.

18. A system as claimed in any of claims 13 to 17, wherein a style specification is in the form of an extensible style language (XSL) stylesheet.

19. A method of automatically distributing data, and information and/or services to a system user in a user specified manner, comprising the steps of:
determining the type of a platform supporting a client making a request
accessing any user preferences and a platform capabilities/requirements specification;
generating a user data requirements specification for transmission to the client; and
transmitting such to the client.

20. A method as claimed in claim 19, further comprising the steps of:
generating a display from the received data requirements specification;
transmitting a request for dynamic or real-time services and/or information to be provided;
receiving the requested services and/or information; and
displaying the services and/or information along with the display generated previously.

21. A method as claimed in claim 20, further comprising the step of a user interacting with a received service.

22. A method as claimed in claim 19, wherein th step of generating a user data requirements specification for transmission to the client, comprises:
generating a first user data requirements specification from the user request;
applying user preferences, if present, to the specification thereby creating an updated or second specification;
applying a corporate or similar branding scheme, if present to the second specification, if present, otherwise the first specification, thereby creating a third specification; and
applying a platform capabilities/requirements style to the third specification, if present, otherwise the second specification, if present, otherwise the first specification, thereby creating a specification for transmission.

23. A system substantially as hereinbefore described with reference to and as shown in FIGS. 1 to 5 of the accompanying drawings.

24. A method substantially as hereinbefore described with reference to and as shown in FIGS. 3 and 4 of the accompanying drawings.
